(19) United States
(12) Patent Application Publication
(10) Pub. No.: US 2025/0299875 A1
(43) Pub. Date: Sep. 25, 2025

(54) IGNITION COIL

(71) Applicant: DIAMOND&ZEBRA ELECTRIC MFG. CO., LTD., Osaka (JP)

(72) Inventors: Takushi NISHIMURA, Osaka-shi (JP); Yukitoshi YAMAGISHI, Osaka-shi (JP); Takaaki MIURA, Osaka-shi (JP); Hiroyuki KIMURA, Osaka-shi (JP)

(73) Assignee: DIAMOND&ZEBRA ELECTRIC MFG. CO., LTD., Osaka (JP)

(21) Appl. No.: 19/061,002

(22) Filed: Feb. 24, 2025

(30) Foreign Application Priority Data
Mar. 22, 2024 (JP) 2024-045931

(51) Int. Cl. H01F 38/12; H01F 27/24; H01F 27/28

(52) U.S. Cl. CPC H01F 38/12; H01F 27/24; H01F 27/28

(57) ABSTRACT

In an ignition coil 2 according to one embodiment, a first outer iron core 360 of a first coil set 10 and a second outer iron core 500 of a second coil set 20 share a common portion 58. The direction of a magnetic flux generated in the common portion 58 upon application of a current flowing through a first primary coil 32 of the first coil set 10 is opposite to the direction of a magnetic flux generated in the common portion 58 upon application of a current flowing through a second primary coil 46 of the second coil set 20. The direction in which an induced current generated in a first secondary coil 34 through an output port 28 is the same as the direction in which an induced current generated in a second secondary coil 48 through the output port 28.

### CROSS-REFERENCE TO RELATED APPLICATIONS

This application claims priority on and the benefit of Patent Application No. 2024-45931 filed in JAPAN on Mar. 22, 2024. The entire disclosures of this Japanese Patent Application are hereby incorporated by reference.

### BACKGROUND OF THE INVENTION

### Field of the Invention

The present specification discloses an ignition coil.

### Description of the Related Art

In an internal combustion engine, an ignition coil is used to bring into operation an ignition plug located in a combustion chamber. The ignition coil typically includes an iron core, a primary coil, a secondary coil, and a switch for switching between application and interruption of a current flowing through the primary coil. In the ignition coil, interruption of the current flowing through the primary coil induces a high electromotive force in the secondary coil. The resulting high voltage is applied to the ignition plug to cause a spark discharge, by which the fuel is ignited.

Recent years have seen the emergence of internal combustion engines running on lean fuel or flame-retardant fuel such as ammonia. Such internal combustion engines require higher energy for ignition and continuous combustion than conventional internal combustion engines. To meet this requirement, ignition coils having two sets each consisting of “an iron core, a primary coil, and a secondary coil” (each set is referred to as a “coil set”) have been investigated and put into practice. For example, Japanese Laid-Open Patent Application Publication No. 2015-129464 discloses an ignition coil in which two coil sets are operated alternately to increase the discharge duration.

In a type of internal combustion engine, an ignition coil is mounted for each of the cylinders. In a multi-point ignition-type engine, a plurality of ignition coils are used for each of the cylinders. Ignition coils having two coil sets occupy large space, and such ignition coils could be an obstacle to size reduction of internal combustion engines. There is a demand for an ignition coil that exhibits high ignition performance and whose size is not so large.

The present inventors aim to provide an ignition coil that exhibits high ignition performance and whose size is not so large.

### SUMMARY OF THE INVENTION

An ignition coil according to one embodiment includes: a first coil set including a first primary coil, a first secondary coil, a first central iron core extending through the first primary coil and the first secondary coil, and a first outer iron core located outside the first primary coil and the first secondary coil; a second coil set including a second primary coil, a second secondary coil, a second central iron core extending through the second primary coil and the second secondary coil, and a second outer iron core located outside the second primary coil and the second secondary coil; and an output port connected to the first secondary coil and the second secondary coil. The first outer iron core and the second outer iron core share a common portion. The direction of a magnetic flux generated in the common portion upon application of a current flowing through the first primary coil in a first direction is opposite to the direction of a magnetic flux generated in the common portion upon application of a current flowing through the second primary coil in a second direction. The direction in which an induced current generated in the first secondary coil upon interruption of the current flowing through the first primary coil in the first direction flows through the output port is the same as the direction in which an induced current generated in the second secondary coil upon interruption of the current flowing through the second primary coil in the second direction flows through the output port.

In the ignition coil, the direction of the induced current generated in the first coil set and the direction of the induced current generated in the second coil set are the same in the output port, while the direction of the magnetic flux generated in the first coil set and the direction of the magnetic flux generated in the second coil set are opposite in the common portion shared by the first outer iron core and the second outer iron core. Since the induced currents generated in the first and second coil sets are outputted in the same direction, the sum of the induced currents can be supplied to an ignition plug. This contributes to high ignition performance. Since the directions of the magnetic fluxes generated in the first and second coil sets are opposite in the common portion, the magnetic fluxes of the first and second coil sets cancel each other in the common portion. It is thus possible to reduce the cross-sectional area of the common portion while avoiding magnetic saturation of the common portion. This can minimize the increase in volume of the ignition coil.

### BRIEF DESCRIPTION OF THE DRAWINGS

FIG. 1 is a circuit diagram of an ignition system including an ignition coil according to one embodiment.

FIG. 2 is a cross-sectional view showing two coil sets of the ignition coil of FIG. 1.

FIG. 3 is a perspective view showing magnets and iron cores of the two coil sets of FIG. 2.

FIG. 4 is a magnetic circuit diagram of the two coil sets of FIG. 2.

FIGS. 5A to 5E show examples of timing charts illustrating a simultaneous current application mode in which the ignition coil of FIG. 1 is operated. FIG. 5A depicts an input signal to a first coil set, FIG. 5B depicts an input signal to a second coil set, FIG. 5C depicts a current flowing through a first primary coil, FIG. 5D depicts a current flowing through a second primary coil, and FIG. 5E depicts an output current of the ignition coil.

FIGS. 6A to 6E show examples of timing charts illustrating the mode of FIGS. 5A to 5E. FIG. 6A depicts an input signal to the first coil set, FIG. 6B depicts an input signal to the second coil set, FIG. 6C depicts a magnetic flux generated in a first central iron core, FIG. 6D depicts a magnetic flux generated in a second central iron core, and FIG. 6E depicts a magnetic flux generated in a common portion.

FIGS. 7A to 7E show examples of timing charts illustrating an alternate current application mode in which the ignition coil of FIG. 1 is operated. FIG. 7A depicts an input signal to the first coil set, FIG. 7B depicts an input signal to the second coil set, FIG. 7C depicts a current flowing through the first primary coil, FIG. 7D depicts a current flowing through the second primary coil, and FIG. 7E depicts an output current of the ignition coil.

FIGS. 8A to 8E show examples of timing charts illustrating the mode of FIGS. 7A to 7E. FIG. 8A depicts an input signal to the first coil set, FIG. 8B depicts an input signal to the second coil set, FIG. 8C depicts a magnetic flux generated in the first central iron core, FIG. 8D depicts a magnetic flux generated in the second central iron core, and FIG. 8E depicts a magnetic flux generated in the common portion.

FIGS. 9A to 9E show examples of timing charts illustrating a combined current application mode in which the ignition coil of FIG. 1 is operated. FIG. 9A depicts an input signal to the first coil set, FIG. 9B depicts an input signal to the second coil set, FIG. 9C depicts a current flowing through the first primary coil, FIG. 9D depicts a current flowing through the second primary coil, and FIG. 9E depicts an output current of the ignition coil.

FIGS. 10A to 10E show examples of timing charts illustrating the mode of FIGS. 9A to 9E. FIG. 10A depicts an input signal to the first coil set, FIG. 10B depicts an input signal to the second coil set, FIG. 10C depicts a magnetic flux generated in the first central iron core, FIG. 10D depicts a magnetic flux generated in the second central iron core, and FIG. 10E depicts a magnetic flux generated in the common portion.

### DETAILED DESCRIPTION

The following will describe preferred embodiments in detail with appropriate reference to the drawings.

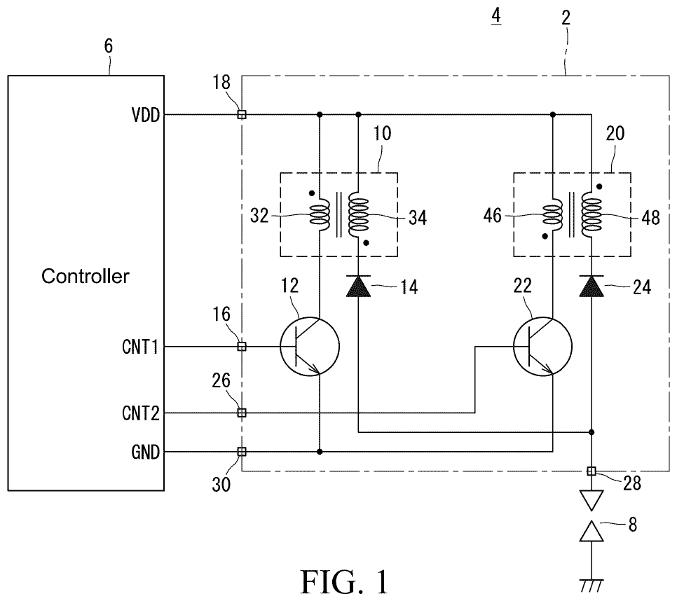

FIG. 1 is a circuit diagram showing an ignition system 4 including an ignition coil 2 according to one embodiment. The ignition system 4 includes a controller 6 and an ignition plug 8 in addition to the ignition coil 2. The ignition plug 8 is located in a combustion chamber of a combustion device such as an engine. The controller 6 is embodied as an ECU in the case where, for example, the ignition system 4 is for use in an automobile.

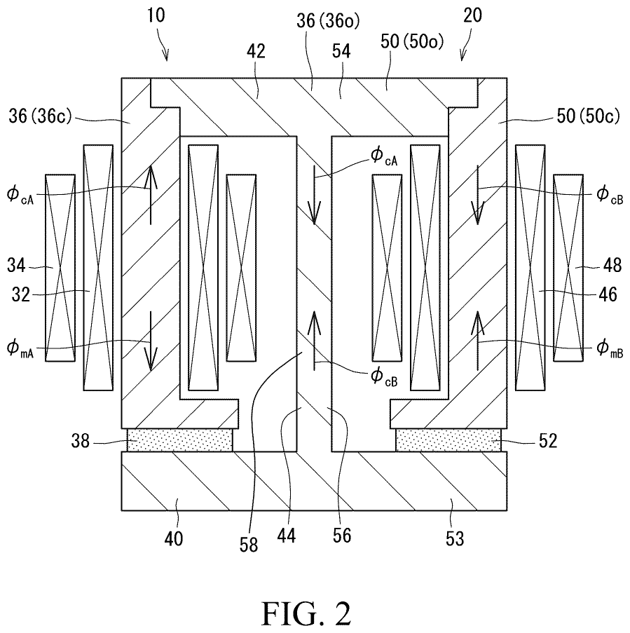

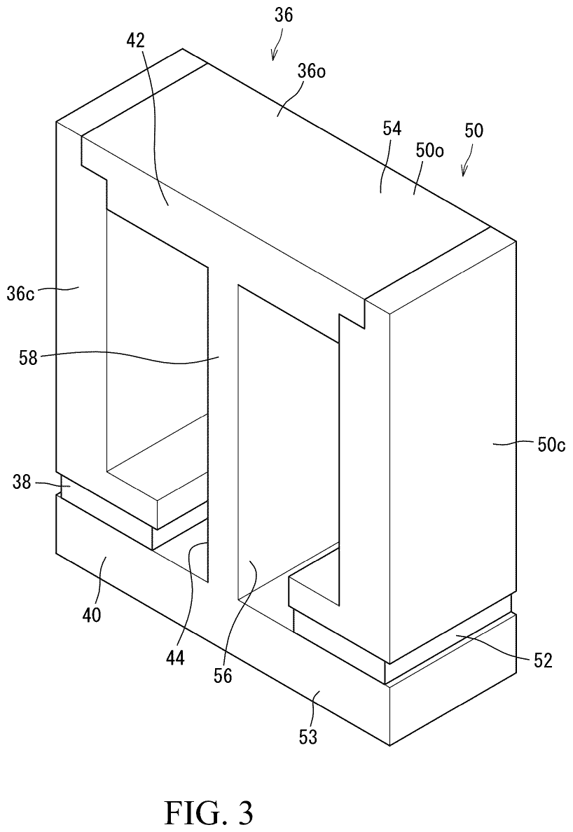

The ignition coil 2 includes a first coil set 10, a first switch 12, a first diode 14, a first control port 16, a second coil set 20, a second switch 22, a second diode 24, a second control port 26, an output port 28, a power port 18, and a ground port 30. FIG. 2 is a cross-sectional view showing the first and second coil sets 10 and 20. FIG. 3 is a perspective view showing only iron cores of the first and second coil sets 10 and 20.

As shown in FIG. 1, the first coil set 10 includes a first primary coil 32, a first secondary coil 34, and a first iron core 36. As shown in FIGS. 2 and 3, the first coil set 10 further includes a first magnet 38, and the first iron core 36 includes a first central iron core 36c and a first outer iron core 360. The first primary coil 32 is formed by winding a wire around the outer periphery of the first central iron core 36c. The first secondary coil 34 is formed by winding a wire around the outer periphery of the first central iron core 36c. A typical material of these wires is copper (Cu). In this embodiment, the first secondary coil 34 is formed outside the first primary coil 32. The number of wire turns in the first secondary coil 34 is much greater than the number of wire turns in the first primary coil 32.

The first central iron core 36c is columnar. In this embodiment, the first central iron core 36c is shaped as a quadrangular column. The first central iron core 36c extends through the centers of the first primary coil 32 and the first secondary coil 34. The first outer iron core 360 extends from one end of the first central iron core 36c, passes outside the first primary coil 32 and the first secondary coil 34, and reaches the other end of the first central iron core 36c. The first outer iron core 360 includes: a lower columnar portion 40 that faces the bottom surface of the one end of the first central iron core 36c; an upper columnar portion 42 that is in contact with a side surface of the other end of the first central iron core 36c; and a beam portion 44 located between the lower columnar portion 40 and the upper columnar portion 42. The beam portion 44 extends parallel to the first central iron core 36c. The first magnet 38 is located adjacent to the one end of the first central iron core 36c. The first magnet 38 is located between the bottom surface of the one end of the first central iron core 36c and the lower columnar portion 40. The first central iron core 36c and the first outer iron core 360 are made of a magnetic material. Preferred examples of the magnetic material include ferrite, dust, and silicon steel.

In this embodiment, the second coil set 20 has the same structure as the first coil set 10. That is, the second coil set 20 includes a second primary coil 46, a second secondary coil 48, and a second iron core 50. The second coil set 20 further includes a second magnet 52, and the second iron core 50 includes a second central iron core 50c and a second outer iron core 500. The second primary coil 46 is formed by winding a wire around the outer periphery of the second central iron core 50c. The second secondary coil 48 is formed by winding a wire around the outer periphery of the second central iron core 50c. A typical material of these wires is copper. In this embodiment, the second secondary coil 48 is formed outside the second primary coil 46. The number of wire turns in the second secondary coil 48 is much greater than the number of wire turns in the second primary coil 46.

The second central iron core 50c is columnar. In this embodiment, the second central iron core 50c is shaped as a quadrangular column. The second central iron core 50c extends through the centers of the second primary coil 46 and the second secondary coil 48. The second outer iron core 500 extends from one end of the second central iron core 50c, passes outside the second primary coil 46 and the second secondary coil 48, and reaches the other end of the second central iron core 50c. The second outer iron core 500 includes: a lower columnar portion 53 that faces the bottom surface of the one end of the second central iron core 50c; an upper columnar portion 54 that is in contact with a side surface of the other end of the second central iron core 50c; and a beam portion 56 located between the lower columnar portion 53 and the upper columnar portion 54. The beam portion 56 extends parallel to the second central iron core 50c. The second magnet 52 is located adjacent to the one end of the second central iron core 50c. The second magnet 52 is located between the bottom surface of the one end of the second central iron core 50c and the lower columnar portion 53. The second central iron core 50c and the second outer iron core 500 are made of a magnetic material. Preferred examples of the magnetic material include ferrite, dust, and silicon steel.

As shown in FIGS. 2 and 3, the first outer iron core 360 and the second outer iron core 500 share a common portion 58. In this embodiment, the beam portion 44 of the first outer iron core 360 and the beam portion 56 of the second outer iron core 500 are embodied as the common portion 58. In this embodiment, the width of the common portion 58 is smaller than the widths of the other portions of the first iron core 36 and the second iron core 50. That is, the cross-sectional area of the common portion 58 is smaller than the cross-sectional areas of the first central iron core 36c and the first outer iron core 360 excluding the common portion 58. The cross-sectional area of the common portion 58 is smaller than the cross-sectional areas of the second central iron core 50c and the second outer iron core 500 excluding the common portion 58. The cross-sectional area of each of the different portions is measured for a cross-section perpendicular to the directions of magnetic fluxes generated in the first and second iron cores 36 and 50. The magnetic fluxes will be described later. In the case where the first central iron core 36c, the first outer iron cores 360 excluding the common portion 58, the second central iron core 50c, the second outer iron core 500 excluding the common portion 58, and the common portion 58 have cross-sectional areas that vary from location to location, each cross-sectional area is measured at the location where the cross-sectional area is at a minimum.

The first switch 12 is located between the first primary coil 32 and the ground port 30. The first control port 16 is connected to the first switch 12. In response to signals from the first control port 16, the first switch 12 switches between a state in which the first primary coil 32 and the ground port 30 are electrically connected (ON) and a state in which the first primary coil 32 and the ground port 30 are electrically disconnected (OFF). In this embodiment, the first switch 12 is an IGBT (insulated gate bipolar transistor). The first switch 12 may be embodied using another device. For example, the first switch 12 may be embodied as a MOSFET.

The second switch 22 is located between the second primary coil 46 and the ground port 30. The second control port 26 is connected to the second switch 22. In response to signals from the second control port 26, the second switch 22 switches between a state in which the second primary coil 46 and the ground port 30 are electrically connected and a state in which the second primary coil 46 and the ground port 30 are electrically disconnected. In this embodiment, the second switch 22 is an IGBT. The second switch 22 may be embodied using another device. For example, the second switch 22 may be embodied as a MOSFET.

The first diode 14 is located between the first secondary coil 34 and the output port 28. The first diode 14 limits the direction in which a current flows through the first secondary coil 34. The second diode 24 is located between the second secondary coil 48 and the output port 28. The second diode 24 limits the direction in which a current flows through the second secondary coil 48.

The power port 18 is connected to the first primary coil 32 and the second primary coil 46. When the first switch 12 is in the connection state, a current is applied from the power port 18 to the first primary coil 32. When the second switch 22 is in the connection state, a current is applied from the power port 18 to the second primary coil 46. In FIG. 2, the arrow ϕ_{cA} represents a magnetic flux generated upon application of a current flowing through the first primary coil 32, and the arrow ϕ_{cB} represents a magnetic flux generated upon application of a current flowing through the second primary coil 46. As shown in FIG. 2, the direction of the magnetic flux ϕ_{cA} is opposite to the direction of the magnetic flux ϕ_{cB} in the common portion 58. In other words, the directions in which the wires of the first and second primary coils 32 and 46 are wound are chosen so that when currents are applied from the power port 18 to the first and second primary coils 32 and 46, the direction of the magnetic flux ϕ_{cA} is opposite to the direction of the magnetic flux ϕ_{cB} in the common portion 58.

In the embodiment of FIG. 1, the same power port 18 is connected to the first and second primary coils 32 and 46. There may be one power port 18 connected to the first primary coil 32 and another power port 18 connected to the second primary coil 46. There may be one ground port 30 connected to the first switch 12 and another ground port 30 connected to the second switch 22.

In FIG. 2, the arrow ϕ_{mA} represents the magnetic flux generated by the first magnet 38. As shown in FIG. 2, the direction of the magnetic flux ϕ_{mA} is opposite to the direction of the magnetic flux ϕ_{cA}. The arrow ϕ_{mB} represents the magnetic flux generated by the second magnet 52. The direction of the magnetic flux ϕ_{mB} is opposite to the direction of the magnetic flux ϕ_{cB}. In other words, the first and second magnets 38 and 52 used are such that the direction of the magnetic flux ϕ_{mA} is opposite to the direction of the magnetic flux ϕ_{cA} and the direction of the magnetic flux ϕ_{mB} is opposite to the direction of the magnetic flux ϕ_{cB}.

The output port 28 is connected to the first and second secondary coils 34 and 48. Interruption of the current flowing through the first primary coil 32 induces an electromotive force in the first secondary coil 34. The induced current is applied from the first secondary coil 34 to the ignition plug 8 through the output port 28. Likewise, interruption of the current flowing through the second primary coil 46 generates an induced current, which is applied from the second secondary coil 48 to the ignition plug 8 through the output port 28. The direction in which the induced current applied from the first secondary coil 34 flows through the output port 28 and the direction in which the induced current applied from the second secondary coil 48 flows through the output port 28 are the same. In other words, the directions in which the wires of the first and second secondary coils 34 and 48 are wound are chosen so that the direction in which the induced current generated in the first secondary coil 34 upon interruption of the current flowing through the first primary coil 32 flows through the output port 28 is the same as the direction in which the induced current generated in the second secondary coil 48 upon interruption of the current flowing through the second primary coil 46 flows through the output port 28.

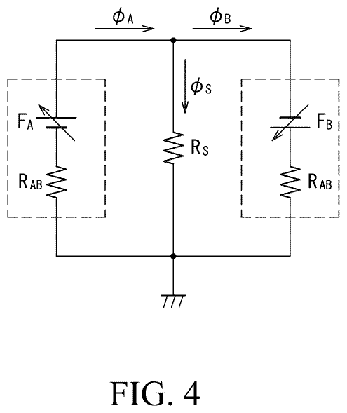

FIG. 4 is a magnetic circuit diagram of the first and second coil sets 10 and 20. In the figure, the reference sign F_{A} represents a magnetomotive force generated by cooperation of the first primary coil 32, the first secondary coil 34, and the first magnet 38 in the first coil set 10. The reference sign F_{B} represents a magnetomotive force generated by cooperation of the second primary coil 46, the second secondary coil 48, and the second magnet 52 in the second coil set 20. The reference sign ϕ_{AB} represents the magnetoresistance of each of the first and second coil sets 10 and 20 excluding the common portion 58. In this embodiment, the magnetoresistance is the same for the first and second coil sets 10 and 20. The reference sign ϕ_{A} represents a magnetic flux passing through the first coil set 10 excluding the common portion 58, and the magnetic flux ϕ_{A} is equal to ϕ_{cA}−ϕ_{mA}. The reference sign ϕ_{B} is a magnetic flux passing through the second coil set 20 excluding the common portion 58, and the magnetic flux ϕ_{B} is equal to ϕ_{cB}−ϕ_{mB}. The reference sign R_{S} is the magnetoresistance of the common portion 58.

In FIG. 4, the reference sign ϕ_{S} represents a magnetic flux passing through the common portion 58, and the magnetic flux ϕ_{S} is expressed by the following equation.

$${ϕ}_{S} = {ϕ}_{A} - {ϕ}_{B} = ( {F}_{A} - {F}_{B} ) / ( {R}_{AB} + 2 {R}_{S} )$$

Assuming that the first and second coil sets 10 and 20 have the same structure and the same current flows through the first and second coil sets 10 and 20, F_{A} is equal to F_{B}. It is understood that the magnetic flux ϕ_{S} is zero in this case.

The controller 6 controls the operation of the ignition coil 2. As shown in FIG. 1, a first control signal CNT1 of the controller 6 is connected to the first control port 16, and a second control signal CNT2 of the controller 6 is connected to the second control port 26. The controller 6 uses the signal CNT1 to switch the first switch 12 between the connection state and the disconnection state and uses the signal CNT2 to switch the second switch 22 between the connection state and the disconnection state. In this embodiment, a power terminal VDD of the controller 6 is connected to the power port 18 of the ignition coil 2. Currents are supplied to the first and second coil sets 10 and 20 from the controller 6.

In this embodiment, the controller 6 can operate the ignition coil 2 in the following modes.
(1) Simultaneous current application mode
   Currents are applied simultaneously to the first coil set 10 and to the second coil set 20.
(2) Alternate current application mode
   Currents are applied alternately to the first coil set 10 and to the second coil set 20.
(3) Combined current application mode
   The simultaneous current application mode and the alternate current application mode are combined.

These modes will be described hereinafter.

### [Simultaneous Current Application Mode]

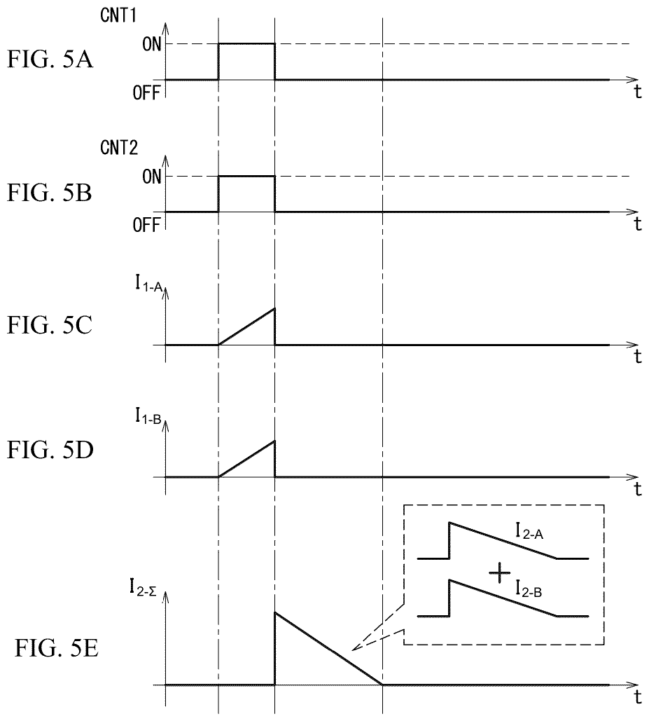

FIGS. 5A to 5E are timing charts illustrating the simultaneous current application mode. In all of FIGS. 5A to 5E, the abscissa represents the time (t). FIG. 5A depicts the first control signal CNT1 inputted to the first switch 12, and FIG. 5B depicts the second control signal CNT2 inputted to the second switch 22. In these figures, the word “ON” means that the first control signal CNT1 has a value for bringing the first switch 12 into the connection state or the second control signal CNT2 has a value for bringing the second switch 22 into the connection state. The word “OFF” means that the first control signal CNT1 has a value for bringing the first switch 12 into the disconnection state or the second control signal CNT2 has a value for bringing the second switch 22 into the disconnection state.

FIG. 5C depicts a current I_{1-A} flowing through the first primary coil 32. Once the first control signal CNT1 is turned “ON”, the first switch 12 is turned on and the current I_{1-A} flows. After that, once the first control signal CNT1 is turned “OFF”, the first switch 12 is turned off and the current I_{1-A} is interrupted. FIG. 5D depicts a current I_{1-B} flowing through the second primary coil 46. Once the second control signal CNT2 is turned “ON”, the second switch 22 is turned on and the current I_{1-B} flows. After that, once the second control signal CNT2 is turned “OFF”, the second switch 22 is turned off and the current I_{1-B} is interrupted. The currents I_{1-A} and I_{1-B} simultaneously begin to flow and are simultaneously interrupted.

FIG. 5E depicts an output current I_{2-Σ} of the ignition coil 2. In the dashed box of FIG. 5E are shown a current I_{2-A} generated in the first secondary coil 34 upon interruption of the current I_{1-A} and a current I_{2-B} generated in the second secondary coil 48 upon interruption of the current I_{1-B}. The currents I_{2-A} and I_{2-B} are generated at the same time point and flow through the output port 28 in the same direction; thus, the output current I_{2-Σ} is the sum of the currents I_{2-A} and I_{2-B} (I_{2-Σ}=I_{2-A}+I_{2-B}).

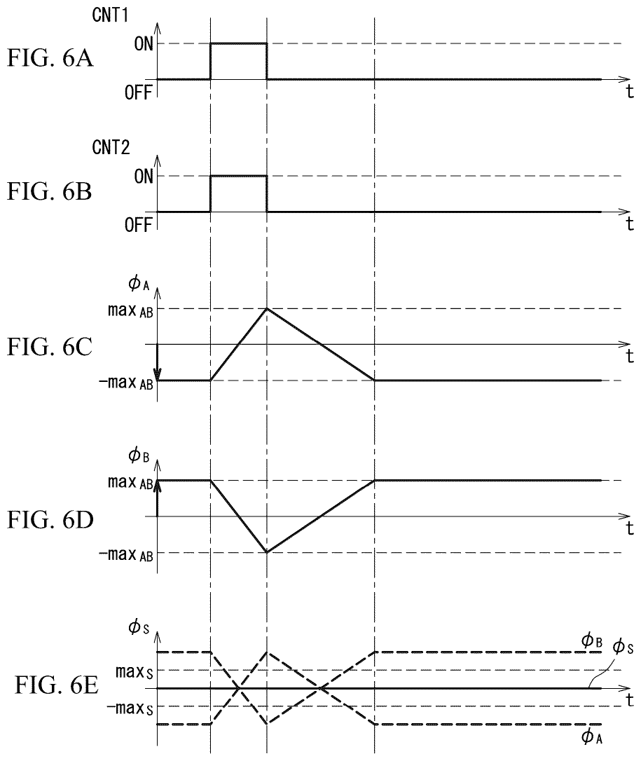

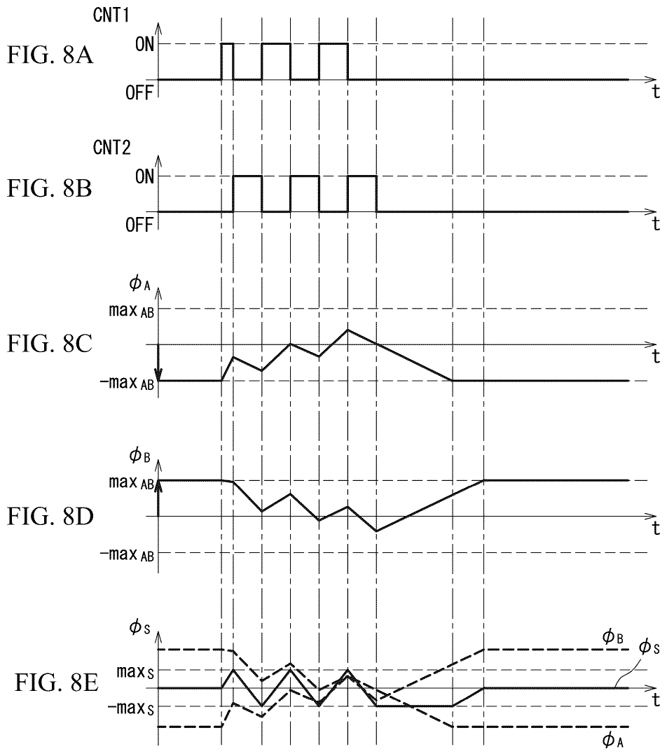

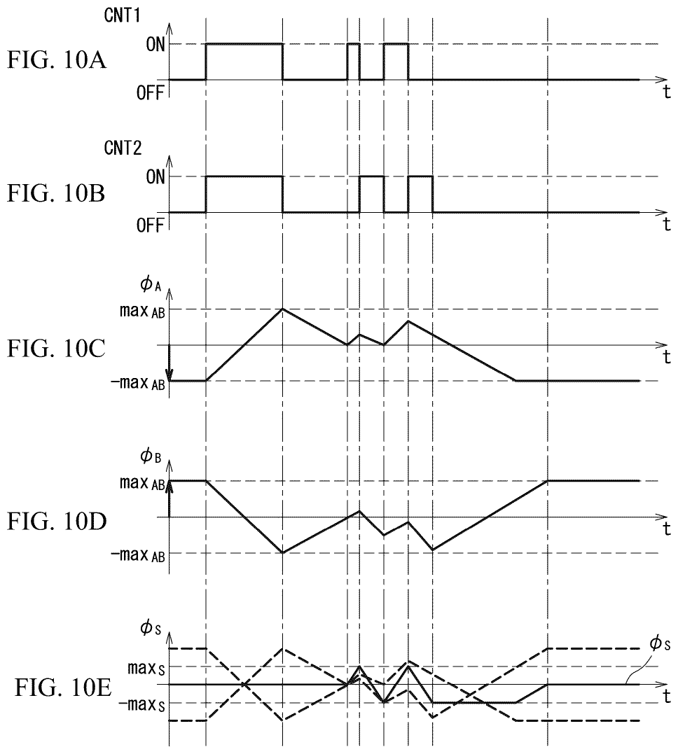

FIGS. 6A to 6E are timing charts illustrating magnetic fluxes generated in the operation mode illustrated in FIGS. 5A to 5E. FIGS. 6A and 6B depict the first and second control signals CNT1 and CNT2 and are the same as FIGS. 5A and 5B, respectively. FIG. 6C depicts the magnetic flux ϕ_{A} and FIG. 6D depicts the magnetic flux ϕ_{B}. In these figures, the directions of the magnetic fluxes are indicated by plus and minus signs. The direction of the magnetic flux ϕ_{cA} generated upon application of a current flowing through the first primary coil 32 is indicated as a positive direction. The same goes for FIGS. 8 and 10 described later. In FIGS. 6C and 6D, max_{AB} and (−max_{AB}) each represent a magnetic flux threshold (referred to as the “maximum magnetic flux level” in the present specification) at which the iron cores excluding the common portion 58 are magnetically saturated. In this embodiment, the maximum magnetic flux level is the same for the first and second coil sets 10 and 20 excluding the common portion 58.

As shown in FIG. 6C, the magnetic flux ϕ_{A} is at (−max_{AB}) before the first control signal CNT1 is turned “ON”. This magnetic flux is one generated by the first magnet 38. In this embodiment, the first magnet 38 used is a magnet that generates a magnetic flux ϕ_{mA} whose magnitude (absolute value) is equal to the maximum magnetic flux level max_{AB}. Once the first control signal CNT1 is turned “ON”, the current I_{1-A} flows and the magnetic flux ϕ_{A} increases. In this embodiment, the magnetic flux ϕ_{A} increases up to the maximum magnetic flux level max_{AB} as the current I_{1-A} flows. Once the first control signal CNT1 is turned “OFF”, the current I_{1-A} is interrupted and the current I_{2-A} flows, so that the magnetic flux ϕ_{A} decreases. The magnetic flux ϕ_{B} depicted in FIG. 6D changes on the same principle as the magnetic flux ϕ_{A}. Since the direction of the magnetic flux ϕ_{B} is opposite to that of the magnetic flux ϕ_{A}, the graph of the magnetic flux ϕ_{B} is opposite in polarity to the graph of the magnetic flux ϕ_{A}. In this embodiment, the second magnet 52 used is a magnet that generates a magnetic flux ϕ_{mB} whose magnitude is equal to the maximum magnetic flux level max_{AB}.

FIG. 6E depicts the magnetic flux ϕ_{S}. In FIG. 6E, the magnetic fluxes ϕ_{A} and ϕ_{B} are also shown by dashed lines. Since the magnetic fluxes ϕ_{A} and ϕ_{B} have opposite polarities, the magnetic flux ϕ_{S} is approximately zero. In FIG. 6E, max_{S} represents the maximum magnetic flux level in the common portion 58. Since the common portion 58 has a smaller cross-sectional area than the other portions of the coil sets, the maximum magnetic flux level max_{S} is smaller than the maximum magnetic flux level max_{AB}. It is understood that the magnetic flux ϕ_{S} does not exceed the maximum magnetic flux level max_{S}, despite the common portion 58 having a smaller cross-sectional area than the other portions of the coil sets.

### [Alternate Current Application Mode]

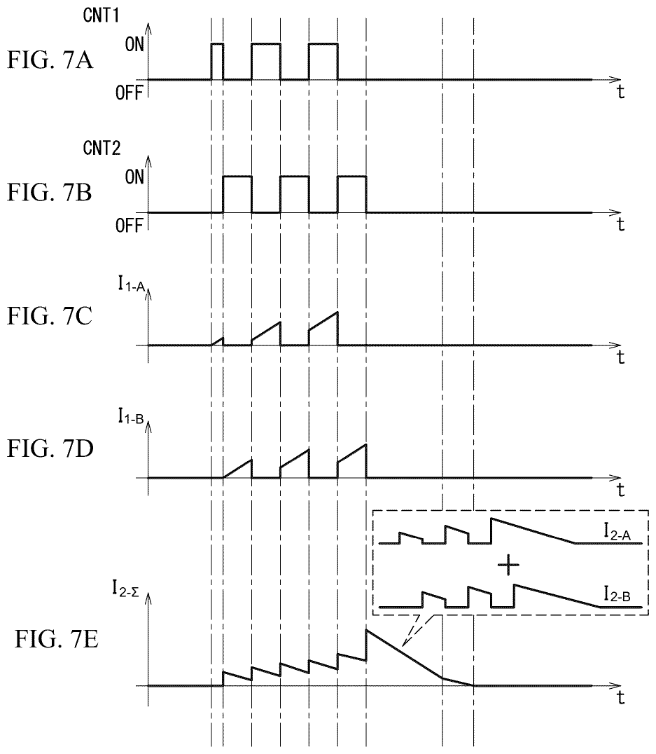

FIGS. 7A to 7E are timing charts illustrating the alternate current application mode. FIG. 7A depicts the first control signal CNT1 and FIG. 7B depicts the second control signal CNT2. The controller 6 outputs the first and second control signals CNT1 and CNT2 as toggle signals in such a manner that “ON” and “OFF” of the first control signal CNT1 alternate one or more times with “ON” and “OFF” of the second control signal CNT2. In this embodiment, when the first control signal CNT1 is “ON”, the second control signal CNT2 is “OFF”, while when the second control signal CNT2 is “ON”, the first control signal CNT1 is “OFF”. The period in which the first control signal CNT1 is “ON” and the period in which the second control signal CNT2 is “ON” may overlap each other.

FIG. 7C depicts the current I_{1-A} flowing through the first primary coil 32. When the first control signal CNT1 is “ON”, the current I_{1-A} flows, while when the first control signal CNT1 is “OFF”, the current I_{1-A} is interrupted. In this embodiment, the current I_{1-A} is applied three times. In this embodiment, as shown in FIG. 7C, the later the current I_{1-A} flows, the higher the peak of the current I_{1-A} is. FIG. 7D depicts the current I_{1-B} flowing through the second primary coil 46. When the second control signal CNT2 is “ON”, the current I_{1-B} flows, while when the second control signal CNT2 is “OFF”, the current I_{1-B} is interrupted. In this embodiment, the later the current I_{1-B} flows, the higher the peak of the current I_{1-B} is. The currents I_{1-A} and I_{1-B} are alternately applied and alternately interrupted.

FIG. 7E depicts the output current I_{2-Σ} of the ignition coil 2. In the dashed box of FIG. 7E are shown the current I_{2-A} generated in the first secondary coil 34 upon interruption of the current I_{1-A} and the current I_{2-B} generated in the second secondary coil 48 upon interruption of the current I_{1-B}. Since the current I_{2-A} flows upon interruption of the current I_{1-A} and the current I_{2-B} flows upon interruption of the current I_{1-B}, the currents I_{2-A} and I_{2-B} are alternately generated. In this embodiment, the later the currents I_{2-A} and I_{2-B} flow, the higher the peak of each of the currents I_{2-A} and I_{2-B} is. The output current I_{2-Σ} is the sum of the currents I_{2-A} and I_{2-B}. It is seen that the current I_{2-Σ} continues to flow from when the first current I_{2-A} begins to flow until the last current I_{2-B} stops flowing.

FIGS. 8A to 8E are timing charts illustrating magnetic fluxes generated during the operation illustrated in FIGS. 7A to 7E. FIGS. 8A and 8B depict the first and second control signals CNT1 and CNT2 and are the same as FIGS. 7A and 7B, respectively. FIG. 8C depicts the magnetic flux ϕ_{A} and FIG. 8D depicts the magnetic flux ϕ_{B}.

As shown in FIG. 8C, when the first control signal CNT1 is “ON”, the magnetic flux ϕ_{A} increases, while when the first control signal CNT1 is “OFF”, the magnetic flux ϕ_{A} decreases. In this embodiment, the increase and decrease are repeated three times. In each repetition, the rate of magnetic flux change (the absolute value of the slope of the graph of the magnetic flux) is higher when the first control signal CNT1 is “ON” than when the first control signal CNT1 is “OFF”. The later is the period in which the first control signal CNT1 is “ON”, the higher is the peak of the magnetic flux in the “ON” period. This is why in FIG. 7C, the peak of the current I_{1-A} rises as the current I_{1-A} flows later.

As shown in FIG. 8D, the magnetic flux ϕ_{B} changes on the same principle as the magnetic flux ϕ_{A}. Since the direction of the magnetic flux OB is opposite to that of the magnetic flux ϕ_{A}, the graph of the magnetic flux ϕ_{B} is opposite in polarity to the graph of the magnetic flux ϕ_{A}. In this embodiment, the decrease and increase of the magnetic flux ϕ_{B} are repeated three times. In each repetition, the rate of magnetic flux change is higher when the second control signal CNT2 is “ON” than when the second control signal CNT2 is “OFF”. The later is the period in which the second control signal CNT2 is “ON”, the higher is the peak (downward peak) of the magnetic flux in the “ON” period.

One way of ensuring that the rate of magnetic flux change is higher when the first control signal CNT1 or the second control signal CNT2 is “ON” than when the signal CNT1 or CNT2 is “OFF” is, for example, to allow the controller 6 to control the voltage of the power terminal VDD to a level sufficiently high relative to the load of the ignition plug 8.

FIG. 8E depicts the magnetic flux ϕ_{S}. In FIG. 8E, the magnetic fluxes ϕ_{A} and ϕ_{B} are also shown by dashed lines. Since the magnetic fluxes ϕ_{A} and B have opposite polarities and cancel each other, the peak (absolute value) of the magnetic flux ϕ_{S} is lower than the peaks of the magnetic fluxes ϕ_{A} and ϕ_{B}. In this embodiment, the magnetic flux ϕ_{S} does not exceed the maximum magnetic flux level max_{S}. In other words, in order to prevent the magnetic flux ϕ_{S} from exceeding the maximum magnetic flux level max_{S}, the controller 6 controls the magnitudes of the currents I_{1-A} and I_{1-B}, the durations of the application and interruption of the currents I_{1-A} and I_{1-B}, and the number of times that the application and interruption of the current I_{1-A} are alternated with the application and interruption of the current I_{1-B}.

### [Combined Current Application Mode]

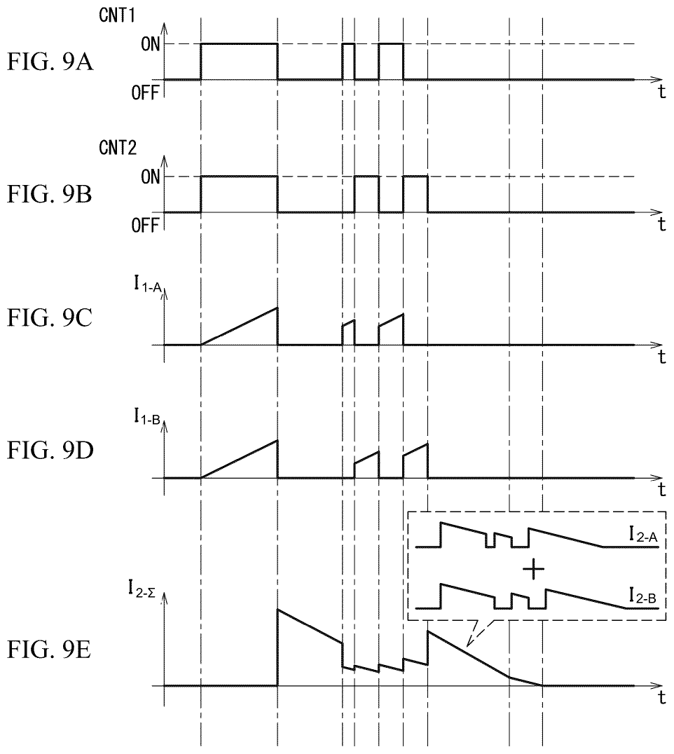

FIGS. 9A to 9E are timing charts illustrating the combined current application mode. FIG. 9A depicts the first control signal CNT1 and FIG. 9B depicts the second control signal CNT2. As in the simultaneous current application mode, the controller 6 turns the first and second control signals CNT1 and CNT2 “ON” simultaneously and thereafter turns the first and second control signals CNT1 and CNT2 “OFF” simultaneously. Subsequently, as in the alternate current application mode, the controller 6 outputs the first and second control signals CNT1 and CNT2 as toggle signals in such a manner that “ON” and “OFF” of the first control signal CNT1 alternate one or more times with “ON” and “OFF” of the second control signal CNT2.

FIG. 9C depicts the current I_{1-A} and FIG. 9D depicts the current I_{1-B}. First, the currents I_{1-A} and I_{1-B} simultaneously begin to flow and are simultaneously interrupted. Subsequently, the currents I_{1-A} and I_{1-B} alternately begin to flow and are alternately interrupted. During the periods in which the currents I_{1-A} and I_{1-B} are alternately applied, the later the currents I_{1-A} and I_{1-B} flow, the higher the peak of each of the currents I_{1-A} and I_{1-B} is.

FIG. 9E depicts the output current I_{2-Σ} of the ignition coil 2. In the dashed box of FIG. 9E are shown the currents I_{2-A} and I_{2-B}. The currents I_{2-A} and I_{2-B} flow simultaneously first and then flow alternately. In this embodiment, the later the currents I_{2-A} or I_{2-B} flow, the higher the peak of each of the currents I_{2-A} and I_{2-B} is. The output current I_{2-Σ} is the sum of the currents I_{2-A} and I_{2-B}. The current I_{2-Σ} reaches a high level when the currents I_{2-A} and I_{2-B} simultaneously flow, and thereafter continues to flow until the last current I_{2-B} stops flowing.

FIGS. 10A to 10E are timing charts illustrating magnetic fluxes generated during the operation illustrated in FIGS. 9A to 9E. FIGS. 10A and 10B depict the first and second control signals CNT1 and CNT2 and are the same as FIGS. 9A and 9B, respectively. FIG. 10C depicts the magnetic flux ϕ_{A} and FIG. 10D depicts the magnetic flux ϕ_{B}.

As shown in FIG. 10C, the magnetic flux ϕ_{A} increases from (−max_{AB}) to max_{AB} during the first one of the periods in which the first control signal CNT1 is “ON”, and decreases during the subsequent “OFF” period. During the next periods in which the first control signal CNT1 toggles, the magnetic flux ϕ_{A} repeatedly increases and decreases. The rate of magnetic flux change is higher when the first control signal CNT1 is “ON” than when the first control signal CNT1 is “OFF”.

As shown in FIG. 10D, the magnetic flux ϕ_{B} changes on the same principle as the magnetic flux A. Since the direction of the magnetic flux OB is opposite to that of the magnetic flux ϕ_{A}, the graph of the magnetic flux OB is opposite in polarity to the graph of the magnetic flux A. That is, the magnetic flux ϕ_{B} decreases from max_{AB} to (−max_{AB}) during the first one of the periods in which the second control signal CNT2 is “ON”, and increases during the subsequent “OFF” period. During the next periods in which the second control signal CNT2 toggles, the magnetic flux ϕ_{B} repeatedly decreases and increases. The rate of magnetic flux change is higher when the second control signal CNT2 is “ON” than when the second control signal CNT2 is “OFF”.

FIG. 10E depicts the magnetic flux ϕ_{S}. In FIG. 10E, the magnetic fluxes ϕ_{A} and ϕ_{B} are also shown by dashed lines. Since the magnetic fluxes A and ϕ_{B} have opposite polarities and cancel each other, the peak (absolute value) of the magnetic flux ϕ_{S} is lower than the peaks of the magnetic fluxes ϕ_{A} and ϕ_{B}. In this embodiment, the magnetic flux ϕ_{S} does not exceed the maximum magnetic flux level max_{S}. In other words, in order to prevent the magnetic flux ϕ_{S} from exceeding the maximum magnetic flux level max_{S}, the controller 6 controls the magnitudes of the currents I_{1-A} and I_{1-B}, the durations of the application and interruption of the currents I_{1-A} and I_{1-B}, and the number of times that the application and interruption of the current I_{1-A} are alternated with the application and interruption of the current I_{1-B}.

The following will describe the workings and effects of the present embodiment.

In the ignition coil 2, the direction of the induced current generated in the first coil set 10 and the direction of the induced current generated in the second coil set 20 are the same in the output port 28, while the direction of the magnetic flux generated in the first coil set 10 and the direction of the magnetic flux generated in the second coil set 20 are opposite in the common portion 58 shared by the first and second outer iron cores 360 and 500. Since the induced currents generated in the first and second coil sets 10 and 20 are outputted in the same direction, the sum of the induced currents can be supplied as an output current to the ignition plug 8. Thus, high ignition energy can be supplied to the ignition plug 8. This contributes to high ignition performance and high continuous combustion performance.

In the ignition coil 2, since the directions of the magnetic fluxes generated in the first and second coil sets 10 and 20 are opposite in the common portion 58, the magnetic fluxes of the first and second coil sets 10 and 20 cancel each other in the common portion 58. This makes it possible to reduce the cross-sectional area of the common portion 58 while avoiding magnetic saturation of the common portion 58. For example, even when currents are applied simultaneously to the first and second coil sets 10 and 20, magnetic saturation of the common portion 58 can be prevented. In the case where currents are applied alternately to the first and second coil sets 10 and 20, magnetic saturation of the common portion 58 can be prevented even when the peaks of the primary currents rise as the primary currents flow later.

The directions in which currents flow through the first and second primary coils 32 and 46 and the directions in which these primary coils are wound are not limited to those in the embodiment of FIG. 1. It is sufficient that the direction of the magnetic flux generated in the first coil set 10 upon application of a current flowing through the first primary coil 32 and the direction of the magnetic flux generated in the second coil set 20 upon application of a current flowing through the second primary coil 46 are opposite in the common portion 58. Assuming that the direction of the current flowing through the first primary coil 32 is a first direction and the direction of the current flowing through the second primary coil 46 is a second direction, the directions in which the first and second secondary coils 34 and 48 are wound are chosen so that the direction in which the induced current generated in the first secondary coil 34 upon interruption of the current flowing through the first primary coil 32 in the first direction flows through the output port 28 is the same as the direction in which the induced current generated in the second secondary coil 48 upon interruption of the current flowing through the second primary coil 46 in the second direction flows through the output port 28.

In this embodiment, the cross-sectional area of the common portion 58 is smaller than the cross-sectional area of the first iron core 36 excluding the common portion 58 and the cross-sectional area of the second iron core 50 excluding the common portion 58. Denoting by Ss the cross-sectional area of the common portion 58 and by Sab the minimum value of the cross-sectional areas of the first and second iron cores 36 and 50 excluding the common portion 58, then the ratio (Ss/Sab) is preferably 70% or less and more preferably 60% or less in order to minimize the increase in volume of the ignition coil 2. In terms of the ease of control for preventing the magnetic flux ϕ_{S} of the common portion 58 from exceeding the maximum magnetic flux level max_{S}, the ratio (Ss/Sab) is preferably 30% or more and more preferably 40% or more.

The first coil set 10 preferably includes the first magnet 38. As previously stated, the first magnet 38 generates a magnetic flux in the first iron core 36, and the direction of the magnetic flux generated by the first magnet 38 is opposite to the direction of the magnetic flux generated in the first iron core 36 upon application of a current flowing through the first primary coil 32. Thus, as shown, for example, in FIG. 6C, the magnetic flux ϕ_{A} generated when any current is not flowing through the first primary coil 32 can have a negative value. In the example of FIG. 6C, the magnetic flux is at (−max_{AB}). The magnetic flux can be increased to the maximum magnetic flux level max_{AB} by application of a current flowing through the first primary coil 32. That is, in the example of FIG. 6C, the maximum amount of change that the magnetic flux ϕ_{A} undergoes due to application of a current flowing through the first primary coil 32 is (2×max_{AB}) which is the amount of change from (−max_{AB}) to max_{AB}. If there is not the first magnet 38, the maximum amount of change of the magnetic flux ϕ_{A} is max_{AB} which is the amount of change from 0 to max_{AB}. It is understood that in the presence of the first magnet 38, the amount of change of the magnetic flux ϕ_{A} can be increased without magnetic flux saturation and be greater than in the absence of the first magnet 38. Increasing the amount of change of the magnetic flux ϕ_{A} leads to an increase in the current I_{2-A} generated in the first secondary coil 34. This contributes to high ignition performance and high continuous combustion performance. For the same reason, the second coil set 20 preferably includes the second magnet 52.

In this embodiment, the controller 6 can operate the ignition coil 2 in the simultaneous current application mode. In the simultaneous current application mode, the first and second coil sets 10 and 20 simultaneously output currents to the output port 28; thus, as shown in FIG. 5E, the amount of the current outputted from the ignition coil 2 can be increased. This contributes to high ignition performance.

In this embodiment, the controller 6 can operate the ignition coil 2 in the alternate current application mode. In the alternate current application mode, the first and second coil sets 10 and 20 alternately output currents to the output port 28; thus, as shown in FIG. 7E, the duration in which the ignition coil 2 outputs a current can be lengthened. This contributes to high ignition performance and high continuous combustion performance.

In this embodiment, the rate of magnetic flux change is higher when the first control signal CNT1 is “ON” than when the first control signal CNT1 is “OFF”. Thus, as shown in FIG. 8C, the later the “ON” period is, the higher is the peak of the magnetic flux ϕ_{A} in the “ON” period. Likewise, when the second control signal CNT2 is “ON”, the rate of magnetic flux change is higher than when the second control signal CNT2 is “OFF”. Thus, as shown in FIG. 8D, the later the “ON” period is, the higher is the peak of the magnetic flux ϕ_{B} in the “ON” period. This allows the output current of the ignition coil 2, as shown in FIG. 7E, to gradually increase as a whole albeit in a stepped fashion.

In this embodiment, the controller 6 can operate the ignition coil 2 in the combined current application mode. In the combined current application mode, the first and second coil sets 10 and 20 simultaneously output currents to the output port 28 at the beginning, and then the first and second coil sets 10 and 20 alternately output currents to the output port 28. It is thus possible, as shown in FIG. 9E, to output a high current first and thereafter continue the current output. This contributes to high ignition performance and high continuous combustion performance.

In this embodiment, in the alternate current application mode and the combined current application mode, the controller 6 controls the magnitudes of the currents I_{1-A} and I_{1-B}, the durations of the application and interruption of the currents I_{1-A} and I_{1-B}, and the number of times that the application and interruption of the current I_{1-A} are alternated with the application and interruption of the current I_{1-B}, so as to prevent the magnetic flux ϕ_{S} from exceeding the maximum magnetic flux level max_{S}. This can prevent magnetic saturation of the common portion 58.

The way of combining simultaneous current application and alternate current application to the first and second coil sets 10 and 20 in the combined current application mode is not limited to that illustrated in FIGS. 9A to 9E. Another way of combination can be envisaged which ensures the high-current output performance of the simultaneous current application and the long-lasting current output performance of the alternate current application.

As described above, the present embodiment can provide an ignition coil that exhibits high ignition performance and whose size is not so large. This demonstrates the superiority of the present embodiment.

### DISCLOSED ITEMS

The following items disclose preferred embodiments.

### [Item 1]

An ignition coil including:
a first coil set including a first primary coil, a first secondary coil, a first central iron core extending through the first primary coil and the first secondary coil, and a first outer iron core located outside the first primary coil and the first secondary coil;
a second coil set including a second primary coil, a second secondary coil, a second central iron core extending through the second primary coil and the second secondary coil, and a second outer iron core located outside the second primary coil and the second secondary coil; and
an output port connected to the first secondary coil and the second secondary coil, wherein
the first outer iron core and the second outer iron core share a common portion,
a direction of a magnetic flux generated in the common portion upon application of a current flowing through the first primary coil in a first direction is opposite to a direction of a magnetic flux generated in the common portion upon application of a current flowing through the second primary coil in a second direction, and
a direction in which an induced current generated in the first secondary coil upon interruption of the current flowing through the first primary coil in the first direction flows through the output port is the same as a direction in which an induced current generated in the second secondary coil upon interruption of the current flowing through the second primary coil in the second direction flows through the output port.

### [Item 2]

The ignition coil according to item 1, wherein a cross-sectional area of the common portion is smaller than a cross-sectional area of the first central iron core, a cross-sectional area of the first outer iron core excluding the common portion, a cross-sectional area of the second central iron core, and a cross-sectional area of the second outer iron core excluding the common portion.

### [Item 3]

The ignition coil according to item 1 or 2, further including:
a first magnet located adjacent to an end of the first central iron core; and
a second magnet located adjacent to an end of the second central iron core, wherein
a direction of a magnetic flux generated in the first central iron core upon application of a current flowing through the first primary coil in the first direction is opposite to a direction of a magnetic flux generated in the first central iron core by the first magnet, and
a direction of a magnetic flux generated in the second central iron core upon application of a current flowing through the second primary coil in the second direction is opposite to a direction of a magnetic flux generated in the second central iron core by the second magnet.

### [Item 4]

A method for controlling the ignition coil according to any one of items 1 to 3, the method including:
applying a current to the first primary coil and simultaneously applying a current to the second primary coil; and
interrupting the current flowing through the first primary coil and simultaneously interrupting the current flowing through the second primary coil.

### [Item 5]

A method for controlling the ignition coil according to any one of items 1 to 3, the method including alternating application and interruption of a current flowing through the first primary coil one or more times with application and interruption of a current flowing through the second primary coil.

### [Item 6]

The method according to item 5, wherein
a rate of magnetic flux change during a period in which a current flows through the first primary coil is higher than a rate of magnetic flux change during a subsequent period in which the current flowing through the first primary coil is interrupted, and
a rate of magnetic flux change during a period in which a current flows through the second primary coil is higher than a rate of magnetic flux change during a subsequent period in which the current flowing through the second primary coil is interrupted.

### [Item 7]

The method according to item 5 or 6, including controlling magnitudes of the currents flowing through the first and second primary coils, durations of the application and interruption of the currents flowing through the first and second primary coils, and the number of times that the application and interruption of the current flowing through the first primary coil are alternated with the application and interruption of the current flowing through the second primary coil, so as to prevent magnetic saturation of the common portion.

### [Item 8]

The method according to any one of items 5 to 7, including:
applying a current to the first primary coil and simultaneously applying a current to the second primary coil;
interrupting the current flowing through the first primary coil and simultaneously interrupting the current flowing through the second primary coil; and
after simultaneously interrupting the currents flowing through the first and second primary coils, alternating application and interruption of a current flowing through the first primary coil one or more times with application and interruption of a current flowing through the second primary coil.

### [Item 9]

An ignition system including:
the ignition coil according to any one of items 1 to 3;
a controller that controls application and interruption of currents flowing through the first primary coil and the second primary coil; and
an ignition plug connected to the output port, wherein
the controller applies a current to the first primary coil and simultaneously applies a current to the second primary coil, and
the controller interrupts the current flowing through the first primary coil and simultaneously interrupts the current flowing through the second primary coil.

### [Item 10]

An ignition system including:
the ignition coil according to any one of items 1 to 3;
a controller that controls application and interruption of currents flowing through the first primary coil and the second primary coil; and
an ignition plug connected to the output port, wherein
the controller alternates application and interruption of a current flowing through the first primary coil one or more times with application and interruption of a current flowing through the second primary coil.

### [Item 11]

The ignition system according to item 10, wherein
a rate of magnetic flux change during a period in which a current flows through the first primary coil is higher than a rate of magnetic flux change during a subsequent period in which the current flowing through the first primary coil is interrupted, and
a rate of magnetic flux change during a period in which a current flows through the second primary coil is higher than a rate of magnetic flux change during a subsequent period in which the current flowing through the second primary coil is interrupted.

### [Item 12]

The ignition system according to item 10 or 11, wherein the controller controls magnitudes of the currents flowing through the first and second primary coils, durations of the application and interruption of the currents flowing through the first and second primary coils, and the number of times that the application and interruption of the current flowing through the first primary coil are alternated with the application and interruption of the current flowing through the second primary coil, so as to prevent magnetic saturation of the common portion.

### [Item 13]

The ignition system according to any one of items 10 to 12, wherein
the controller applies a current to the first primary coil and simultaneously applies a current to the second primary coil,
the controller interrupts the current flowing through the first primary coil and simultaneously interrupts the current flowing through the second primary coil, and
after simultaneously interrupting the currents flowing through the first and second primary coils, the controller alternates application and interruption of a current flowing through the first primary coil one or more times with application and interruption of a current flowing through the second primary coil.

The ignition device as described above is used for ignition in various combustion devices.

The foregoing description is given for illustrative purposes, and various modifications can be made without departing from the principles of the present invention.

1. An ignition coil comprising:
a first coil set including a first primary coil, a first secondary coil, a first central iron core extending through the first primary coil and the first secondary coil, and a first outer iron core located outside the first primary coil and the first secondary coil;
a second coil set including a second primary coil, a second secondary coil, a second central iron core extending through the second primary coil and the second secondary coil, and a second outer iron core located outside the second primary coil and the second secondary coil; and
an output port connected to the first secondary coil and the second secondary coil,
wherein the first outer iron core and the second outer iron core share a common portion,
wherein a direction of a magnetic flux generated in the common portion upon application of a current flowing through the first primary coil in a first direction is opposite to a direction of a magnetic flux generated in the common portion upon application of a current flowing through the second primary coil in a second direction, and
wherein a direction in which an induced current generated in the first secondary coil upon interruption of the current flowing through the first primary coil in the first direction flows through the output port is the same as a direction in which an induced current generated in the second secondary coil upon interruption of the current flowing through the second primary coil in the second direction flows through the output port.

2. The ignition coil according to claim 1, wherein a cross-sectional area of the common portion is smaller than a cross-sectional area of the first central iron core, a cross-sectional area of the first outer iron core excluding the common portion, a cross-sectional area of the second central iron core, and a cross-sectional area of the second outer iron core excluding the common portion.

3. The ignition coil according to claim 1, further comprising:
a first magnet located adjacent to an end of the first central iron core; and
a second magnet located adjacent to an end of the second central iron core, wherein
a direction of a magnetic flux generated in the first central iron core upon application of a current flowing through the first primary coil in the first direction is opposite to a direction of a magnetic flux generated in the first central iron core by the first magnet, and
a direction of a magnetic flux generated in the second central iron core upon application of a current flowing through the second primary coil in the second direction is opposite to a direction of a magnetic flux generated in the second central iron core by the second magnet.

4. A method for controlling the ignition coil according to claim 1, the method comprising:
applying a current to the first primary coil and simultaneously applying a current to the second primary coil; and
interrupting the current flowing through the first primary coil and simultaneously interrupting the current flowing through the second primary coil.

5. A method for controlling the ignition coil according to claim 1, the method comprising alternating application and interruption of a current flowing through the first primary coil one or more times with application and interruption of a current flowing through the second primary coil.

6. The method according to claim 5, wherein a rate of magnetic flux change during a period in which a current flows through the first primary coil is higher than a rate of magnetic flux change during a subsequent period in which the current flowing through the first primary coil is interrupted, and
wherein a rate of magnetic flux change during a period in which a current flows through the second primary coil is higher than a rate of magnetic flux change during a subsequent period in which the current flowing through the second primary coil is interrupted.

7. The method according to claim 5, comprising controlling magnitudes of the currents flowing through the first and second primary coils, durations of the application and interruption of the currents flowing through the first and second primary coils, and the number of times that the application and interruption of the current flowing through the first primary coil are alternated with the application and interruption of the current flowing through the second primary coil, so as to prevent magnetic saturation of the common portion.

8. The method according to claim 5, comprising:
applying a current to the first primary coil and simultaneously applying a current to the second primary coil;
interrupting the current flowing through the first primary coil and simultaneously interrupting the current flowing through the second primary coil; and
after simultaneously interrupting the currents flowing through the first and second primary coils, alternating application and interruption of a current flowing through the first primary coil one or more times with application and interruption of a current flowing through the second primary coil.

9. An ignition system comprising:
the ignition coil according to claim 1;
a controller that controls application and interruption of currents flowing through the first primary coil and the second primary coil; and
an ignition plug connected to the output port,
wherein the controller applies a current to the first primary coil and simultaneously applies a current to the second primary coil, and
wherein the controller interrupts the current flowing through the first primary coil and simultaneously interrupts the current flowing through the second primary coil.

10. An ignition system comprising:
the ignition coil according to claim 1;
a controller that controls application and interruption of currents flowing through the first primary coil and the second primary coil; and
an ignition plug connected to the output port,
wherein the controller alternates application and interruption of a current flowing through the first primary coil one or more times with application and interruption of a current flowing through the second primary coil.

11. The ignition system according to claim 10, wherein a rate of magnetic flux change during a period in which a current flows through the first primary coil is higher than a rate of magnetic flux change during a subsequent period in which the current flowing through the first primary coil is interrupted, and
wherein a rate of magnetic flux change during a period in which a current flows through the second primary coil is higher than a rate of magnetic flux change during a subsequent period in which the current flowing through the second primary coil is interrupted.

12. The ignition system according to claim 10, wherein the controller controls magnitudes of the currents flowing through the first and second primary coils, durations of the application and interruption of the currents flowing through the first and second primary coils, and the number of times that the application and interruption of the current flowing through the first primary coil are alternated with the application and interruption of the current flowing through the second primary coil, so as to prevent magnetic saturation of the common portion.

13. The ignition system according to claim 10, wherein the controller applies a current to the first primary coil and simultaneously applies a current to the second primary coil,
wherein the controller interrupts the current flowing through the first primary coil and simultaneously interrupts the current flowing through the second primary coil, and
wherein after simultaneously interrupting the currents flowing through the first and second primary coils, the controller alternates application and interruption of a current flowing through the first primary coil one or more times with application and interruption of a current flowing through the second primary coil.
